(19) United States
(12) Patent Application Publication
(10) Pub. No.: US 2015/0173309 A1
(43) Pub. Date: Jun. 25, 2015

(54) AUTOMATED VOLUMETRIC IRRIGATION SYSTEM AND METHOD

(71) Applicant: Dow AgroSciences LLC, Indianapolis, IN (US)

(72) Inventors: Kirsti A. Golgotiu, Oregon City, OR (US); Brent Allen Gibson, Hubbard, OR (US); Larry Boyd Rowland, Indianapolis, IN (US)

(21) Appl. No.: 14/537,029

(22) Filed: Nov. 10, 2014

Related U.S. Application Data
(60) Provisional application No. 61/918,071, filed on Dec. 19, 2013.

(51) Int. Cl. A01G 9/24; B05B 12/00; A01G 27/00; B05B 15/06

(52) U.S. Cl. CPC A01G 9/247; B05B 15/061; B05B 12/00; A01G 27/001; A01G 27/003

(57) ABSTRACT

A system and method is disclosed for simultaneously irrigating a plurality of plant containers. The system implements a method which includes providing a plurality of dispensers including a separate dispenser for each of the plurality of plant containers, each dispenser having a known fluid volume capacity; filling each of the plurality of dispensers with a measured volume of fluid; locating the plurality of plant containers below the plurality of dispensers; and dispensing the measured volume of fluid from the plurality of dispensers into corresponding plant containers simultaneously.

### CROSS REFERENCE TO RELATED APPLICATION

This application claims the benefit of U.S. Provisional Patent Application Ser. No. 61/918,071, filed Dec. 19, 2014, the disclosure of which is expressly incorporated by reference herein.

### BACKGROUND AND SUMMARY OF THE DISCLOSURE

The present disclosure relates to a system and method for providing controlled soil moisture conditions within potted plants in a large-scale, automated irrigation system, typically located in a greenhouse.

Fertilization of plantlets grown in containers in a controlled growth environment such as a greenhouse may be accomplished by using liquid fertilization (fertigation) or by incorporating granular macro and micronutrient components into the soil prior to sowing. With either option, precise irrigation is important when uniform and optimum plantlet growth is desired. Precise irrigation is especially important in a screen using pre-incorporated granular urea as disproportionate clear watering may cause leaching of nutrients at an excessive and non-uniform rate and thus result in poor plant growth or nutrient deficient conditions in some plants and not others. This causes the potential for deficient conditions when sufficient conditions are the desired. It may also result in increased plant to plant variability within a treatment group, an effect detrimental to screening experiments that work to detect often very subtle transgenic effects over the background noise from confounding factors (environmental conditions).

In high throughput screening of transgenic plantlets, the solution to precision irrigation must be capable of not only precise watering, but also rapid watering with a low overall equipment footprint to ensure greenhouse growth space is maximized and processing space is minimized. The automated volumetric irrigation system and method of an illustrated embodiment of the present disclosure addresses these requirements and by administering water in precise quantities with flexibility in the total volume dispensed. In an illustrated embodiment, water is supplied directly to a midpoint region of each pot in an automated and time efficient manner.

In one illustrated embodiment of the present disclosure, an automated volumetric irrigation system is provided for simultaneously supplying fluid to an array of plant containers. The illustrated system includes a frame and an array of dispensers coupled to a top portion of the frame. Each dispenser has a known fluid volume capacity, a bottom opening to dispense fluid from the dispenser and a top fluid inlet. The system also includes a fluid supply line coupled to the fluid inlets of the fluid dispensers for selectively filling the dispensers with fluid and a plurality of flexible fluid supply tubes having first and second ends. The first end of each fluid supply tube is coupled to the bottom opening of one of the dispensers and extends downwardly therefrom. The system further includes an array of spray heads. Each spray head is coupled to the second end of one of the fluid supply tubes, and each spray head is aligned with one of the plant containers in the array of plant containers located below the spray heads. The system also includes a fluid flow blocking device coupled to the plurality of fluid supply tubes between the first and second ends. The fluid flow blocking device is selectively actuatable by an actuator to change between an open position to permit fluid flow through the fluid supply tubes and a closed position to block fluid flow through the fluid supply tubes and vice versa.

In an illustrated embodiment, the blocking device includes at least one flow stop tube. Each flow stop tube has a plurality of apertures configured to receive the fluid supply tubes therethrough. The actuator is coupled to the at least one flow stop tube and configured to rotate at least one flow stop tube from the open position to the closed position thereby twisting the fluid supply tubes to block fluid flowing through the supply tubes.

In another illustrated embodiment of the present disclosure, a method is provided for simultaneously irrigating a plurality of plant containers. The method includes providing a plurality of dispensers including a separate dispenser for each of the plurality of plant containers, each dispenser having a known fluid volume capacity; filling each of the plurality of dispensers with a measured volume of fluid; locating the plurality of plant containers below the plurality of dispensers; and dispensing the measured volume of fluid from the plurality of dispensers into corresponding plant containers simultaneously.

In an illustrated embodiment, the method also includes coupling a first end of a flexible fluid supply tube to each of the plurality of dispensers so that a plurality of flexible fluid supply tubes extend downwardly from the plurality of dispensers toward the plant containers; coupling a spray head to a second end of each flexible fluid supply tube; and aligning a spray head with each of plant containers. In an illustrated embodiment, the method further includes twisting the plurality of fluid supply tubes to pinch the plurality of fluid supply tubes closed and block fluid flow through the plurality of fluid supply tubes before filling each of the plurality of dispensers with a measured volume of fluid. After the dispensers are filled with the measured volume of fluid, the method included straightening the fluid supply tubes to permit fluid flow through the plurality of fluid supply tubes, thereby dispensing fluid from the dispensers into corresponding plant containers through the plurality of fluid supply tubes and plurality of spray heads aligned with the plant containers.

### BRIEF DESCRIPTION OF THE DRAWINGS

The foregoing aspects and many additional features of the present system and method will become more readily appreciated and become better understood by reference to the following detailed description when taken in conjunction with the accompanying drawings.

FIG. 1 is a block diagram illustrating components of an automated volumetric irrigation system of the present disclosure;

FIG. 2 is perspective view illustrating one embodiment of the automated volumetric irrigation system;

FIG. 3 is an end view of the irrigation system of FIG. 2;

FIG. 4 is an enlarged view of a portion of the irrigation system of FIGS. 1 and 2 illustrating a plurality of dispensers and a plurality of liquid supply tubes coupled to the dispensers and extending through a fluid flow blocking device to selectively stop fluid flow through the supply tubes;

FIG. 5 is an enlarged view of a portion of irrigation system of FIGS. 1 and 2 illustrating the fluid supply tubes coupled through a manifold to outlet tubes and spray nozzles for supplying fluid to a plurality of plant containers simultaneously;

FIG. 6 is a perspective view illustrating a plurality of fluid supply tubes extending through a flow stop tube of the fluid flow blocking device, with the flow stop tube being positioned to permit fluid flow throw the plurality of fluid supply tubes;

FIG. 7 is a perspective view similar to FIG. 6 where the flow stop tube has been rotated to twist the fluid supply tubes and block fluid flow through the fluid supply tubes;

FIG. 8 is a diagrammatical view illustrating a plurality of fluid dispensers having fluid supply tubes and drain tubes couples to the plurality of dispensers; and

FIG. 9 is a flow chart illustrating operation of the automated volumetric irrigation system of one illustrated embodiment.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates embodiments of the invention, and such exemplifications are not to be construed as limiting the scope of the invention in any manner.

### DETAILED DESCRIPTION OF THE DRAWINGS

For the purposes of promoting an understanding of the principles of the present disclosure, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It is understood that no limitation of the scope of the invention is thereby intended. The invention includes any alterations and further modifications in the illustrated devices and described methods and further applications of the principles of the invention which would normally occur to one skilled in the art to which the invention relates.

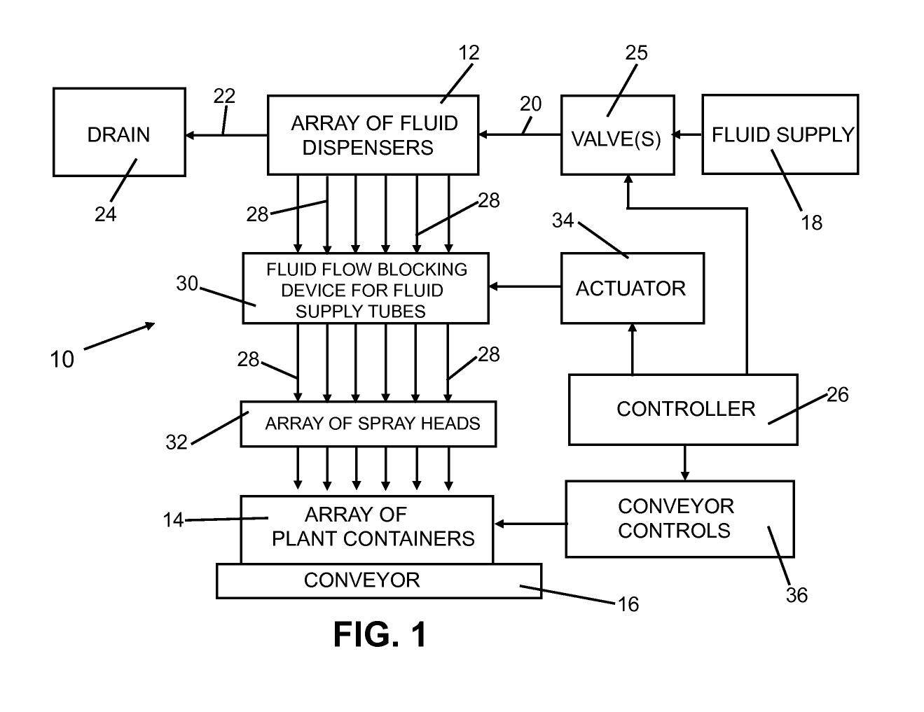

Referring now to the drawings, FIG. 1 is a block diagram illustrating components of an automated volumetric irrigation system 10 of one embodiment of the present disclosure. The irrigation system 10 includes an array of fluid dispensers 12. Each fluid dispenser 12 holds a predetermined known volume of fluid. Fluid from the array of fluid dispensers 12 is used to simultaneously water an array of plant containers 14 located on a track or conveyor 16 below the array of fluid dispensers 12.

A fluid supply 18 is coupled to the array of fluid dispensers 12 by a plurality of fluid supply lines 20. If dispensers 12 are over filled, excess fluid from the dispensers 12 passes through a plurality of drain lines 22 which are coupled to a drain 24. Flow of fluid from the fluid supply 18 to the array of fluid dispensers 12 is either manually controlled or automatically controlled by a controller 26 to selectively open and close at least on fluid supply valve 25.

Each dispenser 12 is coupled to a first end of a downwardly extending fluid supply tube 28. A plurality of fluid supply tubes 28 are coupled to a fluid flow blocking device 30 for selectively permitting flow or blocking flow of fluid through the fluid supply tubes 28. Second ends of the fluid supply tubes 28 coupled to an array of spray heads 32 located above the array of plant containers 14. One spray head 32 is provided for each plant container 14. An actuator 34 is provided to selectively control the blocking device 30 to open and close the supply tubes 28. The actuator 34 may either be a manual actuator such as a lever controlled by an operator or an automatic actuator controlled by controller 26 as discussed below.

The array of plant containers 14 is moved into position beneath the array of spray heads 32 on the conveyor 16 either manually or using conveyor controls 36. After the fluid has been dispensed into the array of plant containers 14, the conveyor controls 36 move the watered array of plant containers 14 and replace it with another array of plant containers 14 in need of watering.

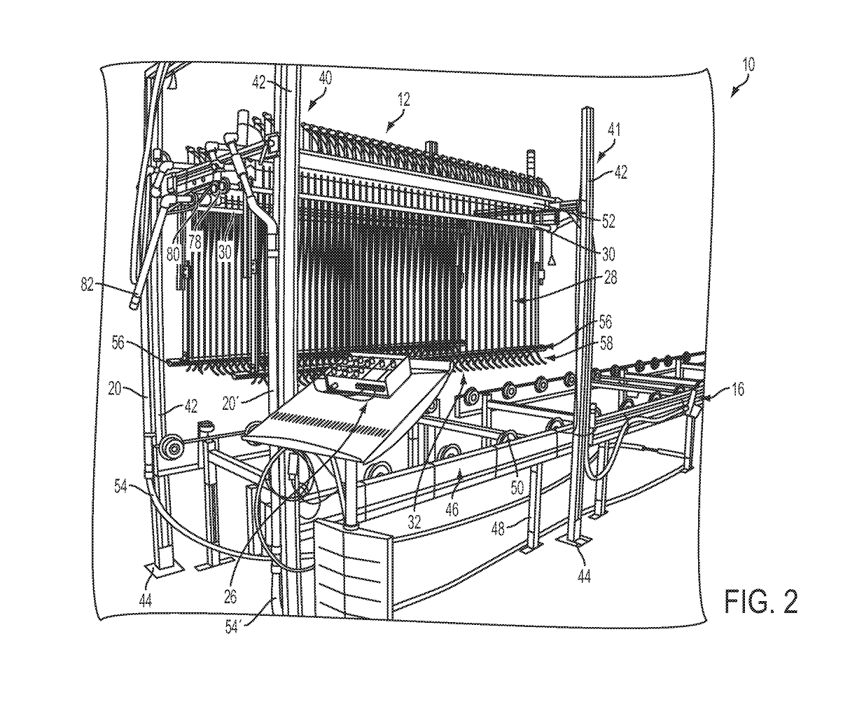

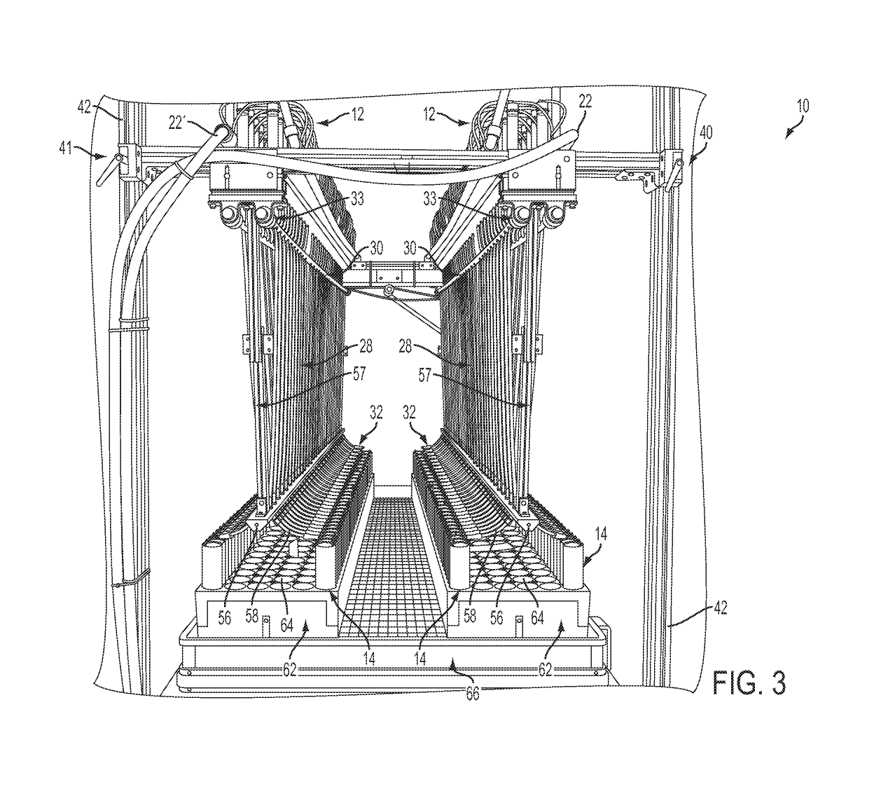

An illustrated embodiment of the automated volumetric irrigation system 10 of the present disclosure is illustrated in FIGS. 2-8. The system 10 includes a frame 40 having vertically extending extruded aluminum legs 42 supported by base plates 44 as shown in FIGS. 2 and 3. Horizontally extending frame members 46 are supported by legs 48 to provide the conveyor 16 as best shown in FIG. 2. A plurality of rollers 50 are coupled to frame members 46 to facilitate movement of the array of plant containers 14 on the conveyor 16. In another embodiment, the frame 40 is mounted on wheels and used indoors or outdoors for small vegetative plots or for rain out shelter fertigation applications.

The array of dispensers 12 is coupled to a top end portion 41 of frame 40 by a plurality of horizontally extending supports 52. The plurality of supply tubes 28 extend downwardly through apertures 31 formed in flow stop tubes 30. First and second fluid supply tubes 20 and 20′ are provided on opposite sides of the frame 40. Tubes 20 and 20′ are coupled to the fluid supply 18 by hoses 54 and 54′, respectively.

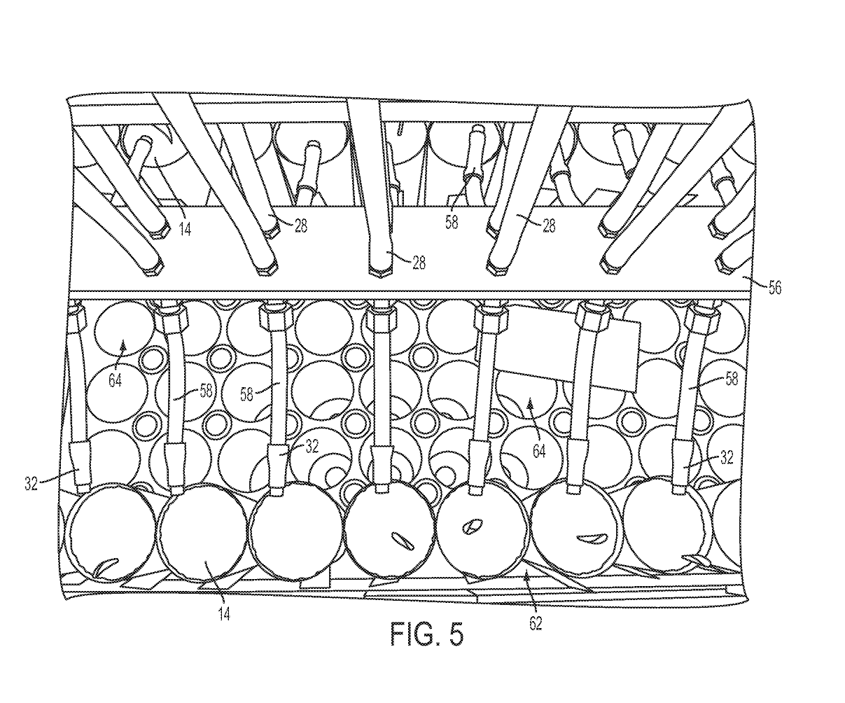

Second ends of the plurality of fluid supply tubes 28 are coupled to two longitudinally extending manifolds 56 located on opposite sides of the frame 40. Manifolds 56 are supported at opposite ends by adjustable end supports 57 as best shown in FIG. 3. Adjustable supports 57 permit a height of each manifold 56 to be adjusted based on the size of plant containers 14. The manifolds 56 have fluid channels that permit passage of water from each fluid supply tube 28 to a corresponding malleable fluid outlet tube 58. Each outlet tube 58 is preferably made of copper and is coupled to a spray nozzle 32 as best shown in FIG. 5. Each spray nozzle 32 is aligned with a center potion of a corresponding plant container 14. Positions of the malleable outlet tubes 58 may be adjusted depending upon the spacing of the plant containers 14.

In the illustrated embodiment, the plant containers 14 are located within a support 62 having a plurality of openings 64 for receiving the containers 14. In the illustrated embodiment, the support 62 is a Styroblock® container available from Beaver Plastics LTD., located in Alberta, Canada. However, it is understood that any suitable support for the array of plant containers 14 may be used.

As best shown in FIG. 3, two separate rows of container supports 62 are provided on the support tray 66. The individual plant containers 14 are illustratively positioned in outer rows of openings 64 of the supports 62. As discussed above, the tray 66 is loaded onto conveyor 16 and moved manually or by automated conveyor controls 36 to the position shown in FIG. 3 so that the plant containers 14 are aligned with the spray heads 32.

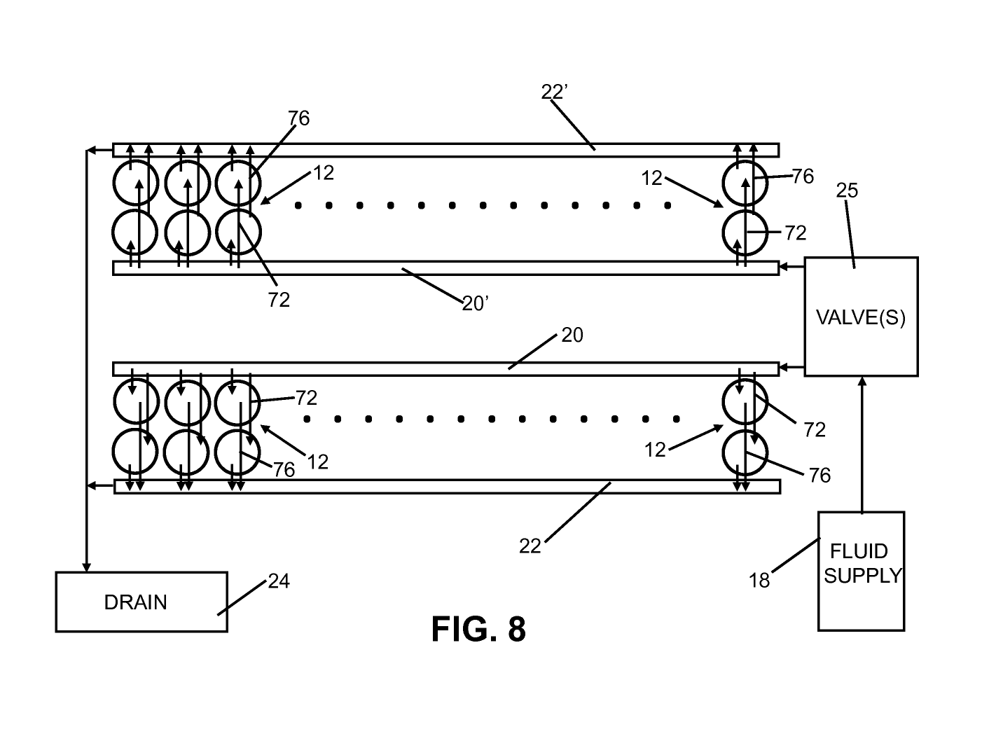

As illustrated diagrammatically in FIG. 8, two rows of dispensers 12 are located adjacent a first side of frame 40 and two rows of dispensers 12 are located adjacent a second side of the frame 40 in an illustrated embodiment. It is understood that other dispenser configurations may also be used. Illustratively, upper supports 52 have openings therein sized to receive the dispensers 12. A pair of fluid supply tubes 20 and 20′ extend longitudinally between opposite ends of the frame 40. Fluid supply tubes 20 and 20′ are coupled to fluid supply 18 through one or more valves 25. Each fluid dispenser 12 is coupled to one of the fluid supply tubes 20 or 20′ by inlet tubes 72. A pair of longitudinally extending drain tubes 22 and 22′ are also located at the upper portion 41 of frame 40 next to the array of dispensers 12. An outlet tube 76 of each dispenser 12 permits venting of air from the dispenser 12 and discharge of overflow fluid from the dispenser. Each outlet tube 76 is coupled to one of the drain tubes 22 or 22′ as shown in FIG. 8. The drain tubes 22 and 22′ are coupled to drain 24.

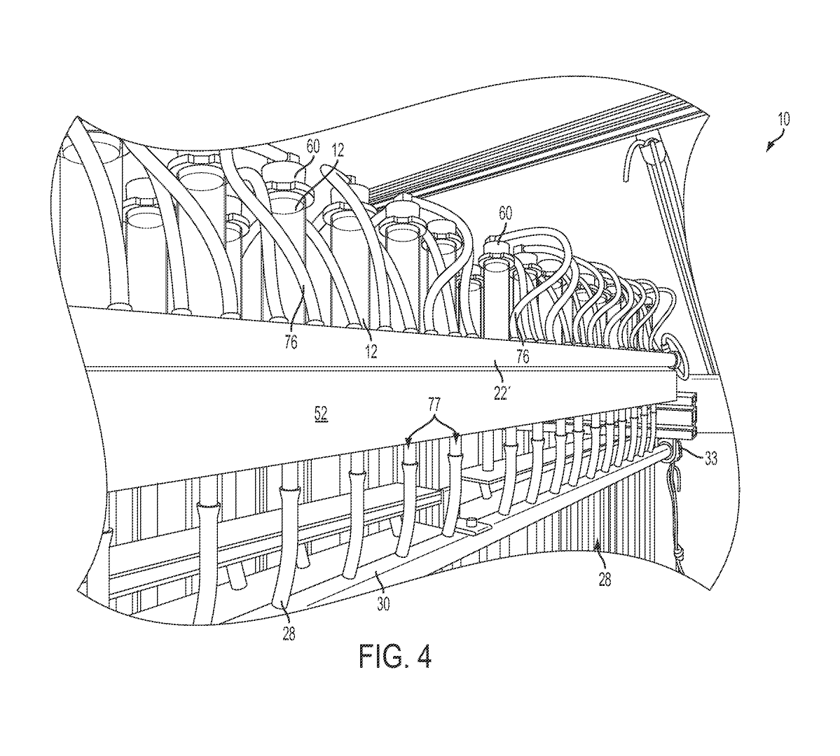

When valve 25 is opened, fluid from fluid supply 18 passes through valve 25 and into fluid supply tubes 20 and 20′. Fluid then enters each of the dispensers 12 through inlet tubes 72. As best shown in FIG. 4, dispensers 12 include a stopper 60 which is positioned at a selected level within the dispenser 12 to adjust the total volume of fluid held by the dispenser. In other words, the stopper 60 is moved to a higher position to increase the fluid capacity of the dispenser 12 or moved to a lower position to decreased fluid capacity of the dispenser 12. Fluid is supplied from fluid supply 18 and inlet tubes 72 until each of the dispensers 12 is filled. To ensure that each dispenser 12 is filled, fluid is provided until fluid begins to drain from the outlet tubes 76 of dispensers 12 as discussed below.

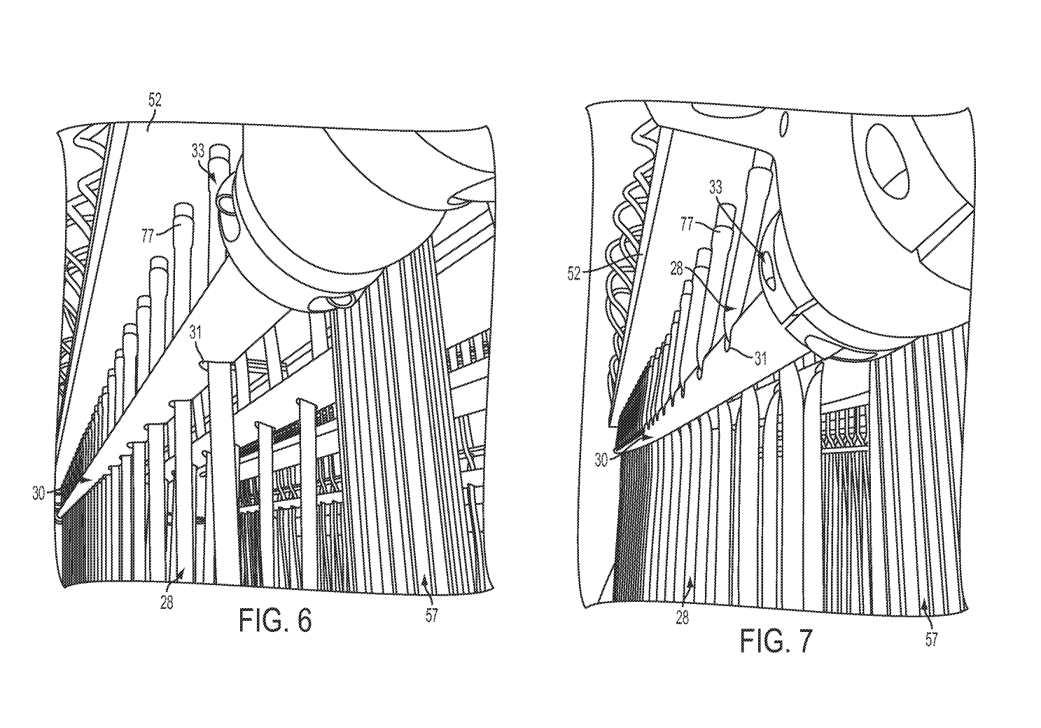

In an illustrated embodiment, dispensers 12 are formed from an inverted plastic transparent syringe having a wide open end at the top and a narrow dispensing end at the bottom. The dispensing ends of the dispensers 12 are place within opening of supports 52. Stoppers 60 provide the upper limit volume for each filling cycle. The stoppers 60 include a first hole having a barb coupled to an inlet tube 72 for water input, and a second hole having a second barb coupled to an outlet tube 76 for ventilation and excess water drainage. A discharge barb fitting 77 (see FIGS. 6 and 7) at the discharge end of each dispenser 12 is coupled to a fluid supply tube 28.

Additional details of the fluid flow blocking device 30 are illustrated in FIGS. 2, 6 and 7. The plurality of supply tubes 28 from dispensers 12 extend downwardly through apertures 31 formed in flow stop tubes 30 as best shown in FIGS. 6 and 7. The fluid supply tubes 28 are preferably made from highly elastic, weather proof, plastic transparent tubing. Each aperture 31 permits a corresponding supply tube 28 to pass through the flow stop tube 30. The flow stop tubes 30 are supported at opposite ends by bearings 33. Tubes 30 are selectively rotatable as shown in FIG. 7 to twist, pinch or kink the plurality of fluid supply tubes 28 thereby blocking fluid flow through the supply tubes 28.

Rotation of the flow stop tubes 30 is illustratively controlled by gears 78 coupled to each of the four flow stop tubes 30 at one end of the irrigation system 10 as shown in FIG. 2. In the illustrated embodiment, a chain drive 80 is provided to rotate the gears 78 simultaneously. In an illustrated embodiment, rotation of the gears 78 to move the flow stop tubes 30 from the open position shown FIG. 6 to the closed position shown in FIG. 7 is controlled by a manual lever 82. In an alternative embodiment, a drive mechanism such motor is used to move the chain 80 to rotate the flow stop tubes 30 under control of controller 26.

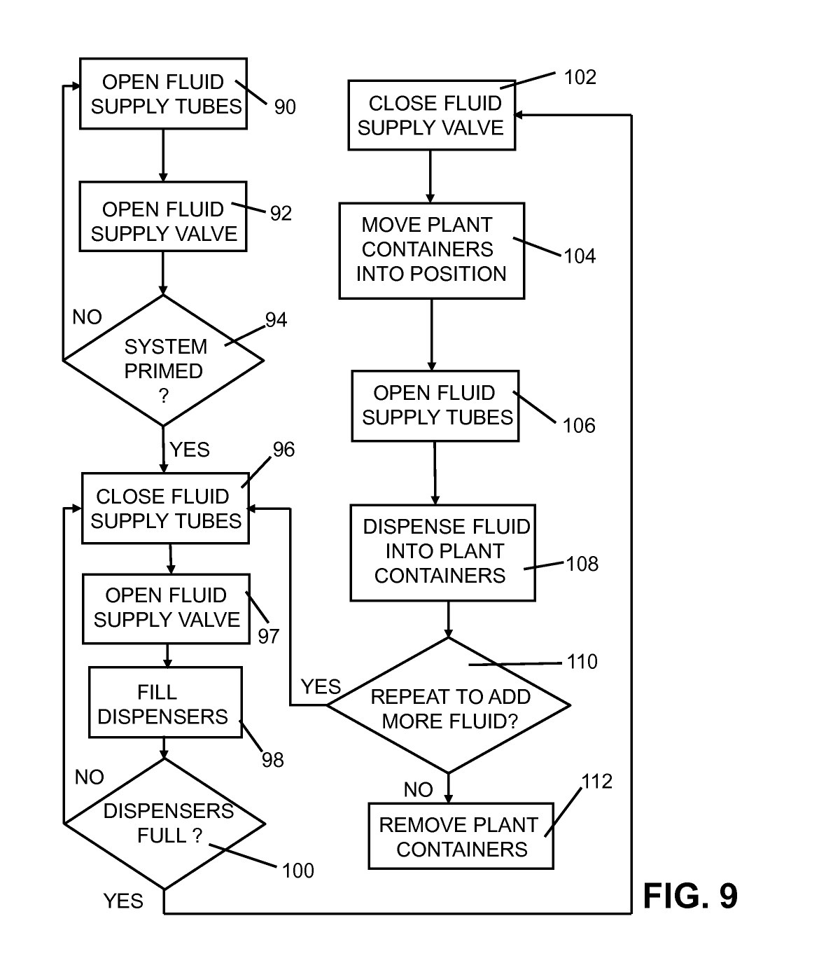

Operation of an exemplary embodiment of the irrigation system 10 is illustrated in FIG. 9. First, an operator flushes or primes the fluid dispensers 12 and the fluid supply tubes 28. The flow stop tubes 30 are moved to the position of FIG. 6 to open the fluid supply tubes 28 as illustrated at block 90 of FIG. 9. Fluid supply valve 25 is opened by actuator 34 as illustrated at block 92 to permit fluid from fluid supply 18 to enter the dispensers 12 through fluid supply lines 20 and 20′ and inlet tubes 72. Since the fluid supply tubes 28 are open, fluid flows through the dispensers 12 and into the fluid supply lines 28 to flush and prime the irrigation system 10. This ensures that no left over fertigation is present in the dispensers 12 or tubes 28, cleans the system of any debris, and ensures that the fluid supply tubes 20 and 20′ are filled for the next watering cycle. If the system is primed at block 94, actuator 34 is actuated by the manual lever 82 or automatically by controller 26 to rotate the flow stop tubes 30 to the position of FIG. 7 to close the fluid supply tubes 28 as illustrated at block 96. If the system is not primed at block 94, the fluid supply tubes remain open at block 90.

Fluid supply valve 25 is opened by actuator 34 (or remains open if previously opened) as illustrated at block 97. Once the fluid supply tubes 28 are closed by the flow stop tubes 30 at block 96 with the valve 25 open, the dispensers 12 are filled with fluid entering the dispensers 12 through inlets 72 from fluid supply lines 20 and 20′ as illustrated at block 98. When the dispensers 12 are full, fluid begins to exit dispensers 12 through outlet tubes 76, drain lines 22 and 22′, and drain 24. By filling the dispensers 12 until some water begins to drain out, the operator knows that the dispensers 12 are completely filled to the full predetermined known volume capacity.

The operator or the controller 26 determines whether the dispensers 12 are full at block 100. If not, the filling operation continues at block 96. If the dispensers are full at block 100, the operator or the controller 26 closes the fluid supply valve(s) 25 as illustrated at block 102.

Next, the tray 66 containing supports holding the array of plant containers 14 is moved into position beneath the spray heads 32 of the irrigation system 10 as best illustrated in FIGS. 3 and 5. Once the array of plant containers 14 is in the proper position at block 104, an operator rotates lever 82 or the controller 26 causes the actuator 34 to rotate the flow stop tubes 30 and open the fluid supply tubes 28 as illustrated at block 106. The fluid supply tubes 28 are shown in the open position in FIG. 6. Opening the fluid supply tubes 28 at block 106 causes fluid contained in dispensers 12 to pass through the plurality of supply tubes 28, through the manifold 56 and outlet tubes 58 to the spray heads 32 and into the plant containers as illustrated at block 108.

Once the fluid is dispensed from the array of dispensers 12, the operator or controller 34 determines whether it is necessary to repeat another filling cycle session to add more fluid to the containers 14. For example, in an illustrated embodiment, the dispensers each hold 60 ml of fluid, if more than 60 ml of fluid is required during the watering cycle, the process is repeated to add additional fluid by returning to block 96 to close the fluid supply tubes at block 96. The fluid supply valve 25 is then opened at block 97 to fill dispensers again as illustrated at block 98. If no more fluid is required for the watering cycle at block 110, the plant containers 14 are removed from beneath the irrigation system 10 so that another array of plant containers 14 can be watered. Total volume delivered by dispensers 12 per cycle may be adjusted by inserting stopper 60 at a different level in the dispenser as discussed above or by using larger/taller dispensers 12. Information related to the measured volume of fluid dispensed into each of the plurality of plant containers 14 is preferably stored as part of a plant study as is known in the art.

In an illustrated embodiment, the dispensers 12 each deliver a measured volume of fluid to each plant container 14 during each dispensing cycle. In an illustrated embodiment, the measured and dispensed volume of 60 ml per dispenser is accurate to a tolerance of +/−4 ml (6.7%). Preferably, the dispensed volume is accurate within +/−10% or less. More preferably, the dispensed volume is accurate within +/−5% or less.

The irrigation system 10 uses mechanical control of water flow to fill, drain off excess fluid, dispense and repeat watering while achieve delivery of a precise volume of water to the plant containers 14. The irrigation system 10 dispenses fluid such as clear water or solutions for fertigation situations in an affordable, power efficient manner. The illustrated irrigation system 10 includes 120 dispensers 12, 120 supply tubes 28 and 120 spray heads 32. Thirty supply tubes 28 pass through each of the four flow stop tubes 30. This illustrated configuration permits automated watering of entire experiments of 2000+ plants in about 1.5 hours. It is understood that different quantities of dispensers 12, supply tubes 28 and spray heads 32 may be used in other embodiments.

As discussed above, the irrigation system 10 is adaptable to accommodate alternate plant/pot spacing, height, quantities, and direction of flow. The spray heads 32 may either provide overhead or below canopy water delivery by adjusting the height and position of spray heads 32. The irrigation system 10 is highly suitable for high throughput screening of various model systems as well as targeted crops and also developmental stages.

While embodiments of the present disclosure have been described as having exemplary designs, the present invention may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this invention pertains.

1. An automated volumetric irrigation system for simultaneously supplying fluid to an array of plant containers, the system comprising:
a frame;
an array of dispensers coupled to a top portion of the frame, each dispenser having a known fluid volume capacity, a bottom opening to dispense fluid from the dispenser and a top fluid inlet;
a fluid supply line coupled to the fluid inlets of the fluid dispensers for selectively filling the dispensers with fluid;
a plurality of flexible fluid supply tubes having first and second ends, the first end of each fluid supply tube being coupled to the bottom opening of one of the dispensers and extending downwardly therefrom;
an array of spray heads, each spray head being coupled to the second end of one of the fluid supply tubes, each spray head being aligned with one of the plant containers in the array of plant containers located below the spray heads; and
a fluid flow blocking device coupled to the plurality of fluid supply tubes between the first and second ends, the fluid flow blocking device being selectively actuatable by an actuator to change between an open position to permit fluid flow through the fluid supply tubes and a closed position to block fluid flow through the fluid supply tubes and vice versa.

2. The system of claim 1, wherein the blocking device includes at least one flow stop tube, each flow stop tube having a plurality of apertures configured to receive the fluid supply tubes therethrough, and wherein the actuator is coupled to the at least one flow stop tube, the actuator being configured to rotate at least one flow stop tube from the open position to the closed position thereby twisting the fluid supply tubes to block fluid flowing through the supply tubes.

3. The system of claim 2, further comprising a gear coupled to each flow stop tube, the gear being rotatable by the actuator to selectively rotate the at least one flow stop tube between the open and closed positions.

4. The system of claim 3, wherein the actuator is a manual lever.

5. The system of claim 3, wherein the actuator automatically rotates the at least one flow stop tube in response to control signals from a controller.

6. The system of claim 1, wherein each dispenser also has a top fluid outlet and further comprising a drain line coupled to the top outlet of each fluid dispenser.

7. The system of claim 1, further comprising at least one longitudinally extending manifold coupled to the frame, the at least one manifold being coupled to the second ends of the fluid supply tubes, and a plurality of rigid fluid outlet tubes, each of the rigid fluid outlet tubes having a first end coupled to the manifold and a second end coupled to one of the spray heads to hold the spray heads in position relative the plurality of plant containers, the at least one manifold having a plurality of fluid channels that permit passage of fluid from each fluid supply tube to a corresponding rigid fluid outlet tube and spray head.

8. The system of claim 7, wherein the plurality of rigid fluid outlet tubes are made from a malleable material to permit adjustment of the positions of the rigid fluid outlet tubes and spray heads relative to the at least one manifold.

9. The system of claim 7, wherein the plurality of rigid fluid outlet tubes extend away from opposite sides of the at least one manifold.

10. The system of claim 7, wherein the at least one manifold is coupled to the frame by an adjustable support to permit a height of each manifold to be adjusted to accommodate different sizes of plant containers.

11. The system of claim 1, further comprising a conveyor located adjacent the frame, the conveyor being configured to support the array of plant containers below the array of spray heads.

12. The system of claim 11, further comprising conveyor controls for automatically moving the array of plant containers into position below the array of spray heads and for automatically removing the array of plant containers from beneath the spray heads once fluid has been dispensed from the dispensers into the array of plant containers.

13. A method for simultaneously irrigating a plurality of plant containers, the method comprising:
providing a plurality of dispensers including a separate dispenser for each of the plurality of plant containers, each dispenser having a known fluid volume capacity;
filling each of the plurality of dispensers with a measured volume of fluid;
locating the plurality of plant containers below the plurality of dispensers; and
dispensing the measured volume of fluid from the plurality of dispensers into corresponding plant containers simultaneously.

14. The method of claim 13, further comprising coupling a first end of a flexible fluid supply tube to each of the plurality of dispensers so that a plurality of flexible fluid supply tubes extend downwardly from the plurality of dispensers toward the plant containers.

15. The method of claim 14, further comprising coupling a spray head to a second end of each flexible fluid supply tube and aligning a spray head with each of plant containers.

16. The method of claim 15, further comprising blocking fluid flow through the plurality of fluid supply tubes before filling each of the plurality of dispensers with a measured volume of fluid and, after the dispensers are filled with the measured volume of fluid, unblocking fluid flow through the plurality of fluid supply tubes to dispense fluid from the dispensers into corresponding plant containers through the plurality of fluid supply tubes and plurality of spray heads aligned with the plant containers.

17. The method of claim 15, further comprising twisting the plurality of fluid supply tubes to pinch the plurality of fluid supply tubes closed and block fluid flow through the plurality of fluid supply tubes before filling each of the plurality of dispensers with a measured volume of fluid and, after the dispensers are filled with the measured volume of fluid, straightening the fluid supply tubes to permit fluid flow through the plurality of fluid supply tubes, thereby dispensing fluid from the dispensers into corresponding plant containers through the plurality of fluid supply tubes and plurality of spray heads aligned with the plant containers.

18. The method of claim 13, wherein filling each of the plurality of dispensers with a measured volume of fluid is accomplished by filling each of the plurality of dispensers with fluid until fluid begins to drain from a fluid outlet of each dispenser so that the plurality of dispensers are all filled to the known fluid volume capacity.

19. The method of claim 13, further comprising repeating filling each of the plurality of dispensers with a measured volume of fluid and dispensing fluid from the plurality of dispensers into corresponding plant containers when a desired fluid volume for each of the plant containers is greater than the known fluid volume capacity of the dispensers.

20. The method of claim 13, wherein the measured volume of fluid dispensed is accurate within +/−10% or less.

21. The method of claim 13, wherein the measured volume of fluid dispensed is accurate within +/−5% or less.

22. The method of claim 13, further comprising storing information related to the measured volume of fluid dispensed into each of the plurality of plant containers.
